(19) United States
(12) Patent Application Publication
(10) Pub. No.: US 2024/0163763 A1
(43) Pub. Date: May 16, 2024

(54) CONNECTION OF REPEATER NODE TO NETWORK

(71) Applicant: Samsung Electronics Co., Ltd., Suwon-si, Gyeonggi-do (KR)

(72) Inventors: Jonas SEDIN, Chertsey (GB); Milos TESANOVIC, Chertsey (GB)

(21) Appl. No.: 18/507,669

(22) Filed: Nov. 13, 2023

(30) Foreign Application Priority Data
Nov. 11, 2022 (GB) 2216883.5

(51) Int. Cl. H04W 36/30

(52) U.S. Cl. CPC H04W 36/305; H04W 84/047

(57) ABSTRACT

A method performed by a network control repeater (NCR) is provided. The method comprises determining whether a radio link failure (RLF) between the NCR and a first base station occurred. The method comprises, in case that the RLF between the NCR and the first base station occurred, performing cell selection for radio resource control (RRC) connection procedure. The method comprises, based on the result of the performing cell selection procedure, performing the RRC connection procedure with a selected base station.

### CROSS-REFERENCE TO RELATED APPLICATION(S)

This application is based on and claims priority under 35 U.S.C. § 119(a) of a United Kingdom patent application number 2216883.5, filed on Nov. 11, 2022, in the United Kingdom Intellectual Property Office, the disclosure of which is incorporated by reference herein in its entirety.

### BACKGROUND

### 1. Field

The disclosure relates to one or more techniques for handling a connection of a repeater node to a network. More particularly, the disclosure relates to one or more techniques for handling connection of a network controlled repeater (NCR) to a radio access network (RAN) node in a 3^{rd} generation partnership project (3GPP) 5^{th} generation (5G) new radio (NR) network following radio link failure (RLF).

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In order to provide enhanced network coverage, a variety of different types of network nodes have been developed. For example, a radio frequency (RF) repeater may be deployed to amplify and forward any signal that it receives to supplement coverage provided by a regular cell. An enhanced type of repeater node, called a network-controlled repeater (NCR), is currently under development and is a Release 18 Study Item/Work Item (3GPP RP-213700).

FIG. 1 illustrates a network architecture of NCR communication according to the related art.

Referring to FIG. 1, the NCR receives and forwards signals from a base station (gNB) to user equipment (UE) via an NCR-Fwd link. The NCR also receives control signals from gNB via a NCR-mobile termination (MT) link, which are used to configure the NCR. Once configured, the NCR provides an amplify-and-forward function that is transparent to the UE. Accordingly, gNB may communicate with UE directly or through an NCR.

To enable easy deployment of NCR nodes, an NCR is configured to be transparent to a UE whether it is communicating through an NCR or not. For example, when an NCR is deployed, to make the NCR transparent to the UE for a random access procedure, the gNB may allocate a set of SSB indices to the NCR when the NCR registers to the network (while other SSB indices remain with gNB), for example as described in 3GPP R1-2203741, Section 5. The UE may then perform the random access procedure via SSBs transmitted via SSB indices allocated to the NCR as though the random access procedure was performed via the gNB.

The NCR-MT part of the NCR is expected to function almost like a normal UE, meaning that the NCR configurations are signaled similar to a normal UE. This means that NCR-MT will have a full protocol stack, but it is expected that some functionality that is normally used by a UE may not be applicable and will not be implemented by the NCR-MT and/or configured by the network.

Radio link failure (RLF) procedures have been introduced to allow a UE to regain its radio link to a base station (or another base station) in case the UE's radio link fails. After RLF is triggered, the UE performs radio resource control (RRC) re-establishment. In this procedure, the UE performs cell selection to select a cell (either a new cell or possibly the same cell) and connects to the selected cell.

The RLF may be declared in a number of cases, for example including the following:

UE out of sync;

The UE measures the cell strength through radio link monitoring. If the cell strength is below a certain threshold a certain number of times, the UE triggers a timer (T310) for the UE to recover. If it does not recover, the UE declares an RLF.

RLC PDUs are re-transmitted a number of times;

The network configures a number of times (maxRetxThreshold) that retransmission of an RLC PDU may be attempted.

Random access problems;

This can occur when the UE is in connected mode and the UE is trying to re-synchronize, for instance after losing uplink synchronization.

Backhaul (BH) RLF (IAB related);

Failure of backhaul links.

Uplink listen before talk (LBT) failure;

This is when the UE fails LBT when on unlicensed band.

As part of performing the RLF procedure, the UE may be configured to gather an RLF-Report which contains information regarding the RLF, which then can be reported to the gNB where it occurred or any other gNB.

FIG. 2 illustrates a RRC re-establishment procedure after RLF according to the related art.

Referring to FIG. 2, the RRC re-establishment procedure (along with RLF). The steps are as follows:

In operation 201, RLF between a UE and a gNB (‘old’ gNB) is declared. This may also be a Handover failure.

In operation 202, the UE performs Idle mode cell selection (in this example selecting ‘new’ gNB).

In operation 203, the UE sends an RRC re-establishment request to the selected new gNB (after first performing random access).

In operation 204, the new gNB requests the UE context from old gNB (if new gNB is not the same as old gNB).

In operation 205, the old gNB provides the requested UE context to new gNB.

In operation 206, the new gNB replies to the RRC re-establishment request in step 3 with a RRC re-establishment message. New gNB may potentially reconfigure UE if needed, or continue using the same previous RRC configuration. If reconfiguring the UE, new gNB replies with RRCSetup message.

In operation 207, the UE responds with RRC re-establishment complete message.

FIG. 3 illustrates a failure indication procedure with an accompanying RLF and RRC re-establishment procedure, as well as RLF Report transmission according to the related art.

Referring to FIG. 3, in operations 301, 302, 303, 304, and 305, to indicate to an old gNB that a UE previously associated/connected to it has failed, a new gNB may signal an RLF indication to the old gNB via the Xn interface. The RLF indication may include, for example, an RLF-Report compiled by the UE.

In some circumstances, such as when RRC re-establishment fails, or if the UE has not yet activated AS security, the UE may have to leave connected mode under the release cause ‘RRC connection failure’. The release cause is relayed to upper layers of the UE-NAS in this case. The action in NAS upon entering RRC idle mode with this release cause is to trigger a tracking area update to any cell according to idle mode procedures.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least advantages described below. Accordingly, an aspect of the disclosure is to provide one or more techniques for handling a connection of a repeater node to a network.

The disclosure is defined in the independent claims. Advantageous features are defined in the dependent claims.

Additional aspects will be set forth in part in the description which follows and, in part, will be apparent from the description, or may be learned by practice of the presented embodiments.

In accordance with an aspect of the disclosure, a method performed by a Network Control Repeater (NCR) in a wireless communication system is provided. The method comprises determining whether a radio link failure (RLF) between the NCR and a first base station occurred. The method comprises in case that the RLF between the NCR and the first base station occurred, performing cell selection for radio resource control (RRC) connection procedure. The method comprises based on the result of the performing cell selection procedure, performing the RRC connection procedure with a selected base station.

In accordance with an aspect of the disclosure, a Network Control Repeater (NCR) in a wireless communication system is provided. The NCR comprises a transmitter, a receiver, and at least one processor coupled to the transmitter and the receiver. The at least one processor is configured to determine whether a radio link failure (RLF) between the NCR and a first base station occurred. The at least one processor is configured to in case that the RLF between the NCR and the first base station occurred, perform cell selection for radio resource control (RRC) connection procedure. The at least one processor is configured to, based on the result of the performing cell selection procedure, perform the RRC connection procedure with a selected base station.

Other aspects, advantages and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a network controlled repeater (NCR) communication architecture in which NCR-mobile termination (MT) is a control link to control a NCR-Fwd link at an NCR according to the related art;

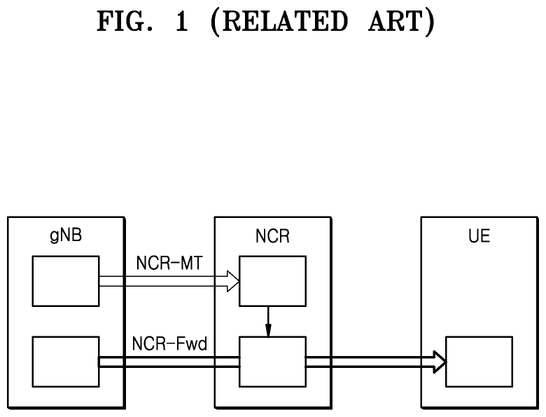

FIG. 2 illustrates a radio resource control (RRC) re-establishment procedure after a radio link failure (RLF) according to the related art;

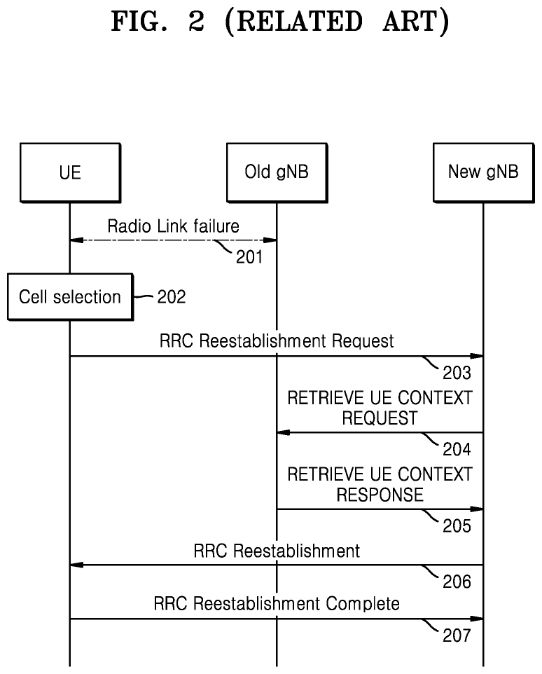

FIG. 3 illustrates a failure indication procedure with an accompanying RLF and RRC re-establishment procedure, as well as RLF Report transmission according to the related art;

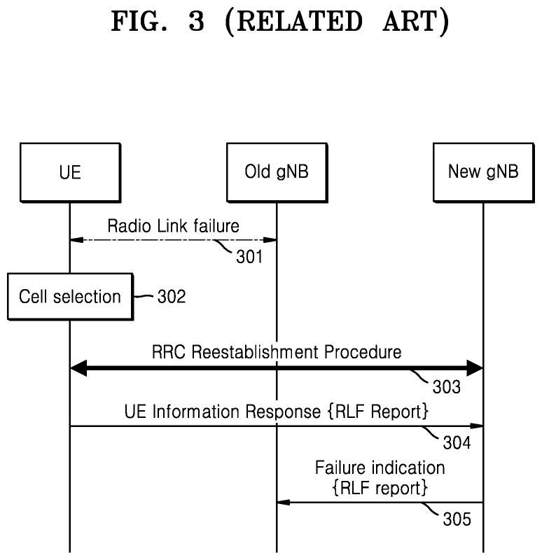

FIG. 4A illustrates an RLF procedure in which cell reselection is not performed according to an embodiment of the disclosure;

FIG. 4B illustrates an RLF procedure in which cell selection is performed to fallback gNBs according to an embodiment of the disclosure;

FIG. 5 illustrates transmission of an NCR indication to a user equipment (UE) and transmission of an NCR recovery indication to the UE once NCR has re-established to a new donor gNB according to an embodiment of the disclosure;

FIG. 6 illustrates transmission of an NCR indication in an RLF Report according to an embodiment of the disclosure;

FIG. 7 illustrates transmission of an NCR failure indication to core network or OAM according to an embodiment of the disclosure;

FIG. 8 illustrates transmission of an NCR-specific RLF report according to an embodiment of the disclosure;

FIG. 9 illustrates an NCR return procedure according to an embodiment of the disclosure; and

FIG. 10 is a block diagram of a network entity according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the disclosure.

The terms and words used herein are not limited to the bibliographical or standard meanings, but, are merely used to enable a clear and consistent understanding of the disclosure.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects. Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment of the disclosure, example or claim are to be understood to be applicable to any other aspect, embodiment of the disclosure, example or claim described herein unless incompatible therewith.

The skilled person will appreciate that the techniques described herein may be used in any suitable combination.

Certain examples of the disclosure provide one or more techniques for handling a connection of a repeater node to a network. For example, certain examples of the disclosure provide one or more techniques for handling connection of a NCR to a RAN node in a 3GPP 5G NR network following RLF. However, the skilled person will appreciate that the disclosure is not limited to these examples, and may be applied in any suitable system or standard, for example one or more existing and/or future generation wireless communication systems or standards, including any existing or future releases of the same standards specification, for example 3GPP 5G.

The following examples are applicable to, and use terminology associated with, 3GPP 5G. However, the skilled person will appreciate that the techniques disclosed herein are not limited to 3GPP 5G. For example, the functionality of the various network entities and other features disclosed herein may be applied to corresponding or equivalent entities or features in other communication systems or standards. Corresponding or equivalent entities or features may be regarded as entities or features that perform the same or similar role, function or purpose within the network.

A particular network entity may be implemented as a network element on a dedicated hardware, as a software instance running on a dedicated hardware, and/or as a virtualised function instantiated on an appropriate platform, e.g., on a cloud infrastructure.

Certain examples of the disclosure may be provided in the form of an apparatus/device/network entity configured to perform one or more defined network functions and/or a method therefor. Certain examples of the disclosure may be provided in the form of a system (e.g., network or wireless communication system) comprising one or more such apparatuses/devices/network entities, and/or a method therefor.

At least the following problem exist in view of the related art:

When a NCR detects/declares RLF compared to when a UE detects/declares RLF, various behaviour/requirements are currently undefined, for example including the following:

How does an NCR perform cell selection during re-establishment. For example, can the NCR freely connect to any cell?

How should NCR-MT RLF be indicated to a UE connecting through an NCR?

How should an NCR failure be indicated to the network, to a new gNB, to the old gNB, to the core network and/or to the OAM, so that the network may perform appropriate actions?

What is reported in an NCR RLF report? What is reported to the gNB and what is reported to UEs attaching to the NCR?

What action(s) should be taken when an NCR fails the re-establishment procedure?

Certain examples of the disclosure provide one or more techniques, for an NCR (e.g., NCR-MT) and/or a UE attaching to the network via an NCR, for performing RLF and RRC re-establishment.

The skilled person will appreciate that the techniques disclosed herein may be applied to gNBs, for example, NG-RAN gNB. The skilled person will also appreciate that the techniques disclosed herein may also be applied to NCR-MTs in EN-DC.

Various techniques will now be described below. The skilled person will appreciate that these techniques may be applied in any suitable combination.

1. Fallback (Donor-)gNB

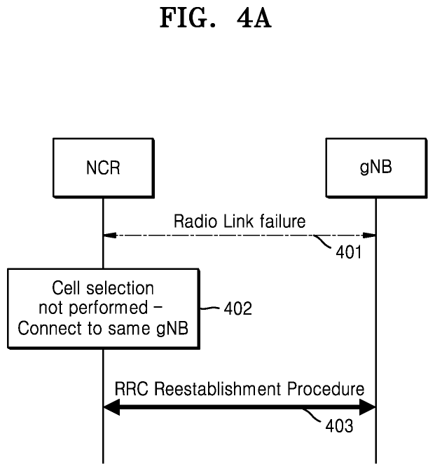

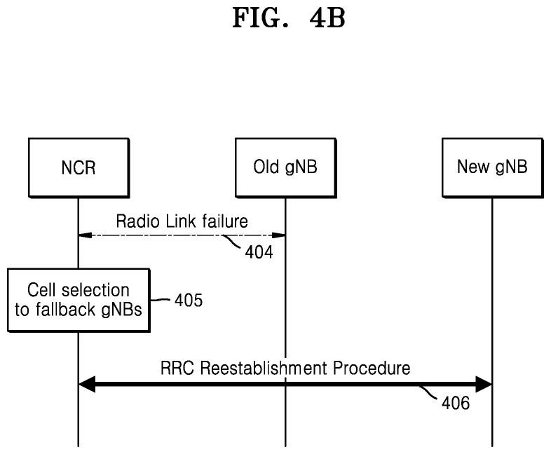

FIG. 4A illustrates an RLF procedure in which cell reselection is not performed according to an embodiment of the disclosure.

Referring to FIG. 4A, in operation 401, when an NCR (e.g., NCR-MT) declares RLF, the NCR selects a cell in operation 402 with which to perform RRC Re-establishment in operation 403. In certain examples, the NCR may select the same cell with which the NCR was previously connected prior to RLF. For example, in the cell selection mechanism, the NCR does not select a cell that is different from the previously connected cell. This may be advantageous in cases in which an NCR is pre-configured in advance regarding which donor gNB it should be connected to, such that the NCR may not be allowed to attempt to connect to any cell. For example, in some cases a donor gNB shall only have a single NCR, for example due to the bandwidth usage of having an NCR connected to it. An example of this technique is illustrated in FIG. 4A.

FIG. 4B illustrates an RLF procedure in which cell selection is performed to fallback gNBs according to an embodiment of the disclosure.

Referring to FIG. 4B, in operations 404, 405, and 406, the NCR may be pre-configured with a number of potential fallback donor gNBs from which a cell may be selected. This may be advantageous in cases in which the donor gNBs can be both macro and smaller cells. An example of this technique is illustrated in FIG. 4B. In certain examples, the NCR may be pre-configured with a number of potential fallback donor gNBs, and the NCR may select a cell from among these candidate gNBs when one or more criteria are satisfied. For example, if the frequency of occurrence of RLF when connecting (and re-connecting) to a given cell is greater than a threshold, the NCR may instead select a (different) cell from among a set of pre-configured cells.

In certain examples, the candidate cells may be configured in multiple NCRs through a broadcast message, or may be configured in one or more specific NCR through one or more NCR-specific messages, for example through dedicated RRC signaling. In certain examples, the candidate cells may be configured through OAM in advance, or during the initial NCR connection and set-up.

In one example, the above technique may be implemented by configuring the NCR with one or more NCR-specific cell (re-)selection parameters to be used in case of RLF or re-establishment. This could for instance be achieved by transmitting, via RRC, a dedicated SIB2 (SystemInformationBlock containing one or more cell (re-) selection parameters) that (only) concerns parameters to be used for NCR when performing RLF and re-establishment.

### Example 1

In the following example of the above techniques, the NCR-MT re-selects the same donor gNB and does not perform cell selection.
------------------3GPP TS 38.331 V17.2.0--------------------
5.3.7 RRC connection re-establishment
5.3.7.1 General
. . .

Upon initiation of the procedure, the UE shall:
1> stop timer T310, if running;
1> stop timer T312, if running;
1> stop timer T304, if running;
1> start timer T311;
1> stop timer T316, if running;
1> release sl-L2RelayUE-Config, if configured;
1> release sl-L2RernoteUE-Config, if configured;
1> release the SRAP entity, if configured;
1> if the UE is acting as L2 U2N Remote UE:
2> if the PC5-RRC connection with the U2N Relay UE is determined to be released:
3> indicate upper layers to trigger PC5 unicast link release;
3> perform either cell selection in accordance with the cell selection process as specified in TS 38.304 [20], or relay selection as specified in clause 5.8.15.3, or both;
2> else (i.e., maintain the PC5 RRC connection):
3> consider the connected L2 U2N Relay UE as suitable and perform actions as specified in clause 5.3.7.3a;
NOTE 1: It is up to Remote UE implementation whether to release or keep the current PC5 unicast link.
else:
   2> if the UE is acting as an NCR-MT:
      3> consider the same cell to have been selected and follow procedures as specified in 5.3.7.3
   2> else:
   3> perform cell selection in accordance with the cell selection process as specified in TS 38.304 [20].
------------------3GPP TS 38.331 V17.2.0------------------

### Example 2

In the following example of the above techniques, the network configures NCR-specific cell reselection parameters via dedicated delivery of SIB2.
------------------3GPP TS 38.331 V17.2.0------------------
   RRCReconfiguration

The RRCReconfiguration message is the command to modify an RRC connection. It may convey information for measurement configuration, mobility control, radio resource configuration (including RBs, MAC main configuration and physical channel configuration) and AS security configuration.

```
          Signaling radio bearer: SRB1 or SRB3
          RLC-SAP: AM
          Logical channel: DCCH
          Direction: Network to UE
          RRCReconfiguration message
          -- ASN1START
          -- TAG-RRCRECONFIGURATION-START
          RRCReconfiguration ::= SEQUENCE {
            rrc-TransactionIdentifier  RRC-TransactionIdentifier,
            criticalExtensions CHOICE {
              rrcReconfiguration RRCReconfiguration-IEs,
              criticalExtensionsFuture  SEQUENCE { }
            }
          }
          ...
          RRCReconfiguration-v1530-IEs ::=  SEQUENCE {
            masterCellGroup OCTET STRING (CONTAINING
CellGroupConfig) OPTIONAL, -- Need M
            fullConfig ENUMERATED {true} OPTIONAL,
-- Cond FullConfig
          dedicatedNAS-MessageList SEQUENCE (SIZE(1..maxDRB)) OF
DedicatedNAS-Message
          OPTIONAL, -- Cond nonHO
            masterKey Update MasterKeyUpdate OPTIONAL, --
Cond MasterKeyChange
            dedicatedSIB1-Delivery OCTET STRING (CONTAINING SIB1)
OPTIONAL, -- Need N
            dedicatedSystemInformationDelivery OCTET STRING
(CONTAINING SystemInformation) OPTIONAL, -- Need N
            otherConfig OtherConfig   OPTIONAL, -- Need M
            nonCriticalExtension   RRCReconfiguration-v1540-IEs
OPTIONAL
          }
          -- TAG-RRCRECONFIGURATION-STOP
          -- ASN1STOP
```

RRCReconfiguration-IEs field descriptions
. . .
dedicatedSystemInformationDelivery
This field is used to transfer SIB6, SIB7, SIB8, SIB19, SIB21 to
the UE with an active BWP with no common search space
configured or the L2 U2N Remote UE in RRC_CONNECTED.
For UEs in RRC_CONNECTED (including L2 U2N Remote
UE), this field is used to transfer the SIBs requested on-demand.
For NCR this field is used to transfer SIB2 dedicated for use
in NCR RLF case by listing cell fallback options.

------------------3GPP TS 38.331 V17.2.0------------------

2. NCR Indicating Failure to UE

In certain examples, the NCR may send to UEs connecting to it an indication that RLF was detected on the NCR-MT to gNB link, for example through specific L1/L2 signaling.

In certain examples, this indication may be in a form such that it appears from the UE's point of view to come from donor gNB. For example, the indication may be in the form of existing gNB signaling, for example instructing the UE to look for alternative cells (e.g., an RRC release message). The UE may then take any suitable action according to receipt of RLF indication from gNB. This technique maintains NCR transparency, such that the UE is not aware that it is connecting to the network via an NCR.

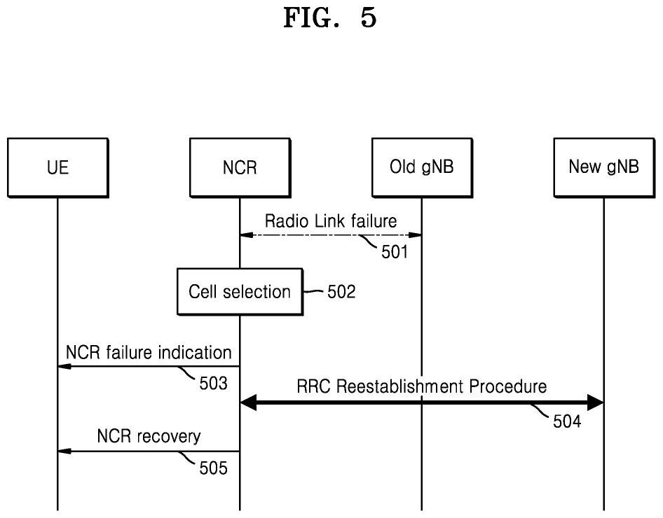

FIG. 5 illustrates transmission of an NCR indication to a UE and transmission of an NCR recovery indication to the UE once NCR has re-established to a new donor gNB according to an embodiment of the disclosure.

Referring to FIG. 5, in, when receiving an RLF indication from an NCR in operation 501 (or from a donor gNB where the RLF indication refers to the NCR-to-gNB link), a UE may not actually treat this as an indication of RLF with the donor gNB in terms of what action to take in response, but may take alternative action in operation 502. For example, as illustrated in FIG. 5, when receiving an NCR failure indication from the NCR in operation 503, the UE may wait for completion of an RRC re-establishment procedure in operation 504 between the NCR and donor gNB and then perform an NCR recovery procedure in operation 505. In certain examples, the gNB may configure the NCR according to the above technique when the NCR declares an RLF.

In certain examples an RLF detection indication (indicating RLF has been detected but not declared) and/or an RLF declared indication may be sent to a UE.

In certain examples, after NCR has detected RLF on the link between the NCR and the gNB, the NCR may send a message, for example RRC Release, to UEs associated with the NCR. The NCR may also provide an indication to the donor gNB, for example during the re-establishment procedure. For example, this may be indicated in the NCR Failure report.

In certain examples, an RLF detection indication may be sent to UE(s) attaching to the NCR. Once a new link is established between the NCR and either the old donor gNB or a new donor gNB, an indication of RLF recovery may be sent to the UEs. For example, if the NCR re-connects to an old gNB, the indication may be a PDCCH-ordered random access in order to bring all the UEs back into synchronization. The PDCCH-ordered random access may trigger the UEs to perform random access so that any lost synchronization can be re-gained. On the other hand, if the NCR re-connects to a new gNB, then a reconfiguration with sync procedure (a handover) may be performed to ensure that UEs connect to the new donor gNB. Since it would be the NCR that sends the reconfiguration with sync (a handover), this behaviour can be configured by the donor gNBs or other network elements.

3. NCR RLF Indication and Re-Establishment

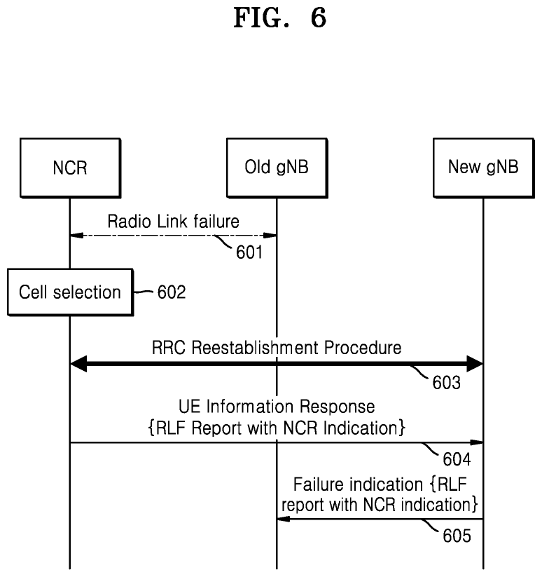

FIG. 6 illustrates transmission of an NCR indication in an RLF Report according to an embodiment of the disclosure.

Referring to FIG. 6, in certain examples, if the NCR performs an RLF procedure in operation 601 and then connects to another donor gNB in operations 602 and 603, the new gNB may send an indication to the old donor gNB that the NCR has failed. For example, this may be achieved by sending an indication in the RLF Indication that the RLF Report is for an NCR. In certain examples the NCR-MT may include a flag in the RLF report indicating to the network that the “UE” is an NCR node in operation 604. In other examples the NCR-MT may be identified as NCR without this flag, for example based on its C-RNTI or other radio/CN identifiers. In certain examples, the new donor gNB may include an NCR indication in the RLF indication itself in operation 605. An example of this technique is illustrated in FIG. 6.

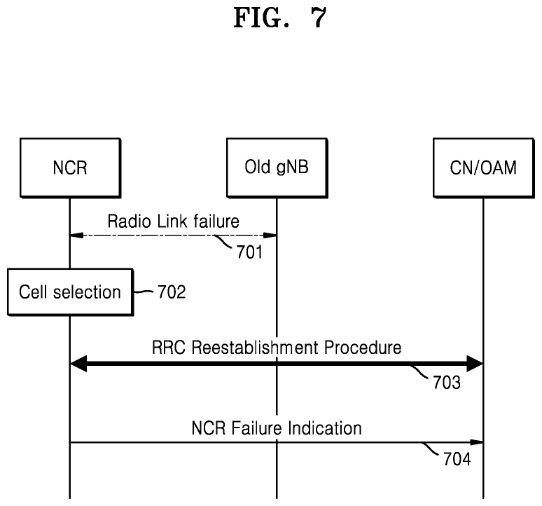

FIG. 7 illustrates transmission of an NCR failure indication to core network or OAM according to an embodiment of the disclosure.

Referring to FIG. 7, in operations 701 and 702, if the NCR is unable to find a suitable NCR-capable donor gNB when performing the re-establishment procedure in operation 703, the NCR may be configured to connect to a gNB that is not NCR capable. Thereafter, the NCR (acting as a UE to the gNB) may signal, for example to the core network or the OAM, that a failure has occurred in operation 704. This allows the core network or OAM to reconfigure the NCR, or allows reporting to an operator that there is a problem with the NCR setup, configuration or deployment. An example of this technique is illustrated in FIG. 7.

In certain examples, the method described above in which a flag is included in the RLF report to indicate NCR identity may be used. The report may then be sent to the previous gNB, which may then properly interpret the signaled flag.

4. NCR RLF Report

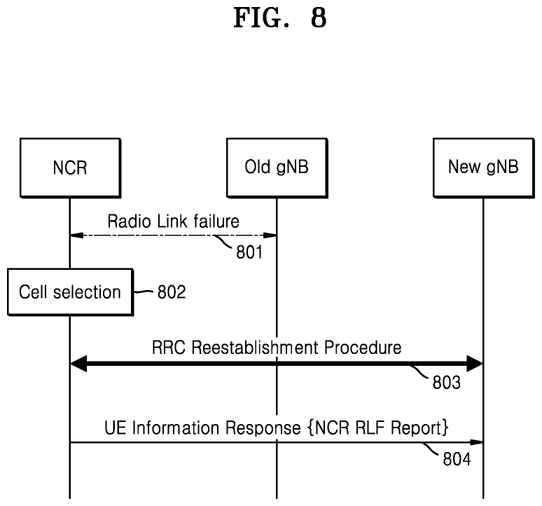

FIG. 8 illustrates transmission of an NCR-specific RLF report according to an embodiment of the disclosure.

Referring to FIG. 8, in operations 801, 802, 803, and 804, the NCR report may provide NCR specific failure information to the donor gNB. An example of this technique is illustrated in FIG. 8.

The NCR report may include any suitable information, for example one or more of the following:

Whether the UE was in NCR Fwd on/off mode.

Buffer data occupancy at NCR-Fwd, the volume of packets transmitted whose reception status is unconfirmed and/or are awaiting retransmission, or any other suitable indicators of data to/from UEs which have not been successfully delivered.

Load indicators, for example how much of the NCR bandwidth is being used and/or how many UEs attach to the NCR and/or channel conditions/link status updates on access links.

Any NCR specific configuration that the NCR was configured with, for example the configurations of the NCR-Fwd, such as whether the NCR-Fwd was ON/OFF, which beams that were being utilized or any other NCR-Fwd configuration or state.

How many UEs connected through the NCR.

5. NCR Re-Establishment Procedure

In certain examples, when an NCR node performs RLF or fails Re-establishment, the NCR may not indicate to upper layers that the release cause is for ‘RRC connection failure’. In this case, the NCR node will not be configured to perform a tracking area update. This may be important as an NCR node may not be configured to perform any tracking area updates, for example since it may be a stationary node, and/or a network may not be configured to handle a tracking area update from an NCR.

In certain examples, if the NCR is unable to find any suitable donor gNBs with NCR support, the NCR may perform a tracking area update as a normal UE, and may indicate, for example to the core network or OAM, transparently to a gNB.

6. NCR Return Procedure

In some cases, if RLF occurs between an NCR and a first gNB, and then the NCR performs re-establishment with a second gNB, then a problem may occur if the second gNB accepts and continues the connection with the NCR. For example, if an operator has configured the first gNB to operate the NCR (e.g., based on using OAM or manual configurations), then it may be preferable to provide a mechanism to regain the NCR connection with the first gNB, or to avoid the NCR connection with the second gNB.

In certain examples, if RLF occurs, the first gNB may indicate that it requires the NCR to re-reconnect to the first gNB. For example, this may be achieved by the first gNB indicating to the second gNB that it requires the NCR to be handed back to the first gNB.

In certain examples, a suitable indication to the second gNB may be sent in any suitable message, for example a separate (e.g., newly defined) message, or any suitable pre-existing message, for example RETRIEVE UE CONTEXT FAILURE/RETRIEVE UE CONTEXT RESPONSE. In certain examples the indication may be provided in the form of a flag, for example returnNCR-Request.

In certain examples, the return of the NCR may be done via handover through RRCReconfiguration with sync, which is connected mode handover, or via RRC Release with redirection.

The indication to first gNB that the NCR has connected to the second gNB may be done through any suitable technique, for example any of the techniques disclosed above (e.g., under Item 3 above).

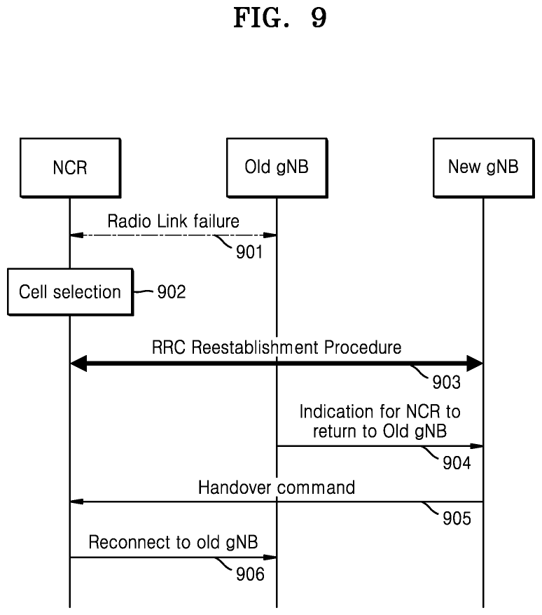

An example of this technique is illustrated in FIG. 9.

FIG. 9 illustrates an NCR return procedure according to an embodiment of the disclosure.

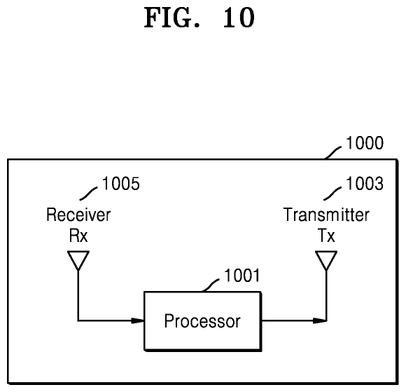

FIG. 10 is a block diagram of a network entity according to an embodiment of the disclosure. The skilled person will appreciate that a network entity may be implemented, for example, as a network element on a dedicated hardware, as a software instance running on a dedicated hardware, and/or as a virtualised function instantiated on an appropriate platform, e.g., on a cloud infrastructure.

Referring to FIGS. 9 and 10, in operations 901, 902, 903, 904, 905, and 906 of FIG. 9 and elements of FIG. 10, an entity 1000 includes a processor (or controller) 1001, a transmitter 1003 and a receiver 1005. The receiver 1005 is configured for receiving one or more messages from one or more other network entities, for example as described above. The transmitter 1003 is configured for transmitting one or more messages to one or more other network entities, for example as described above. The processor 1001 is configured for performing one or more operations, for example according to the operations as described above.

The techniques described herein may be implemented using any suitably configured apparatus and/or system. Such an apparatus and/or system may be configured to perform a method according to any aspect, embodiment of the disclosure, example or claim disclosed herein. Such an apparatus may include one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the disclosure may be implemented in the form of hardware, software or any combination of hardware and software. Any such software may be stored in the form of a volatile or a non-volatile storage, for example a storage device like a ROM, whether erasable or rewritable, or in the form of a memory, such as, for example, a RAM, memory chips, a device or integrated circuits or on an optically or magnetically readable medium, such as, for example, a CD, a DVD, a magnetic disk or a magnetic tape, or the like.

It will be appreciated that the storage devices and storage media are embodiments of machine-readable storage that are suitable for storing a program or programs including instructions that, when executed, implement certain examples of the disclosure. Accordingly, certain examples provide a program including code for implementing a method, apparatus or system according to any example, embodiment of the disclosure, aspect and/or claim disclosed herein, and/or a machine-readable storage storing such a program. Still further, such programs may be conveyed electronically via any medium, for example a communication signal carried over a wired or wireless connection.

Certain examples of the disclosure provide a method, for a network control repeater (NCR), the method including determining that a connection between the NCR and a first radio access network (RAN) node has been terminated (e.g., due to RLF or handover), selecting a RAN node for performing an RRC connection procedure with the NCR, and performing the connection procedure with the selected RAN node.

In certain examples, selecting the RAN node may include selecting the first RAN node based on a configuration of the NCR.

In certain examples, selecting the RAN node may include selecting a RAN node other than the first RAN node.

In certain examples, the RAN node other than the first RAN node may be selected if one or more certain criteria are satisfied.

In certain examples, the one or more criteria may include termination of the connection between the NCR and the first RAN node has occurred a number of times above a certain threshold within a certain time window.

In certain examples, the method may further include obtaining a list of RAN nodes, and wherein selecting the RAN node includes selecting the RAN node from among the list of RAN nodes.

In certain examples, the list of RAN nodes may be obtained according to one or more of a configuration (e.g., via OAM/RRC/NAS signaling), a pre-configuration (e.g., via OAM), through a broadcast signal; and through a SIB2 in an RRC message.

In certain examples, the method may further include transmitting, to one or more UEs connected to the NCR, an indication that the connection between the NCR and the first RAN node has been terminated.

In certain examples, the indication may be transmitted in a message of a type (e.g., RRC release message) transmitted by the first RAN node to a UE for indicating that a connection between the first RAN node and the UE has been terminated.

In certain examples, the indication may indicate that termination of the connection has been detected but not declared.

In certain examples, the method may further include when a connection between the NCR and the selected RAN node is established, transmitting, to the one or more UEs, an indication that the connection is established.

In certain examples, the method may further include transmitting, to the selected RAN node, information relating to the terminated connection (e.g., an RLF report).

In certain examples, the method may further include transmitting, by the selected RAN node, to the first RAN node, information relating to the terminated connection (e.g., an RLF report).

In certain examples, the information transmitted by the selected RAN node may include an indication that the terminated connection was a connection to the NCR.

In certain examples, the information relating to the terminated connection may include information indicating one or more of how many UEs were connected through the NCR, whether the NCR was in NCR Fwd on/off mode, a buffer data occupancy of the NCR, a volume of data to/from a UE which have not been successfully delivered, a load indicator relating to the NCR; and one or more NCR configurations the NCR was configured with.

In certain examples, when no RAN node capable of supporting the NCR is available, the selected RAN node may be a RAN node not capable of supporting the NCR, and the method may further include transmitting, to a core network entity, a message indicating that a connection has been terminated.

In certain examples, when a connection cannot be established between the NCR and a RAN node, the NCR may not perform either or both of a tracking area update and RAN based notification area update.

In certain examples, the method may further include when no RAN node capable of supporting the NCR is available, performing a tracking area update as a UE.

Certain examples of the disclosure provide an apparatus (e.g., a network control repeater) configured to perform a method according to any aspect, example, claim or embodiment disclosed herein.

Certain examples of the disclosure provide a network (or wireless communication system) including an apparatus according to any aspect, example, claim or embodiment disclosed herein.

Certain examples of the disclosure provide a computer program including instructions which, when the program is executed by a computer or processor, cause the computer or processor to carry out a method according to any aspect, example, claim or embodiment disclosed herein.

Certain examples of the disclosure provide a computer or processor-readable data carrier having stored thereon a computer program according to any aspect, example, claim or embodiment disclosed herein.

While the disclosure has been shown and described with reference to various embodiments thereof, it will be understood by those skilled in the art that various changes in form and details may be made therein without departing from the spirit and scope of the disclosure as defined by the appended claims and their equivalents.

In accordance with an aspect of the disclosure, a method performed by a Network Control Repeater (NCR) in a wireless communication system is provided. The method comprises determining whether a radio link failure (RLF) between the NCR and a first base station occurred. The method comprises in case that the RLF between the NCR and the first base station occurred, performing cell selection for radio resource control (RRC) connection procedure. The method comprises based on the result of the performing cell selection procedure, performing the RRC connection procedure with a selected base station.

According to an embodiment of the disclosure, the performing of the cell selection comprises selecting the first base station based on a configuration of the NCR.

According to an embodiment of the disclosure, the method further comprises obtaining a list of base stations. And the performing of the cell selection comprises selecting a second base station based on the list of the base stations.

According to an embodiment of the disclosure, the list of the base stations comprises at least one of candidate base stations or forbidden base stations. The candidate base stations are allowed to connect with the NCR and the forbidden base stations are not allowed to connect with the NCR.

According to an embodiment of the disclosure, the list of the base stations is obtained from an operations, administration and maintenance (OAM).

According to an embodiment of the disclosure, the method further comprises in case that the RLF between the NCR and the first base station occurred, transmitting to a UE connected to the NCR an indication that the RLF occurred between the NCR and the first base station.

According to an embodiment of the disclosure, the method further comprises in case that the RRC connection between the NCR and the selected base station is established, transmitting, to a UE connected to the NCR, an indication indicating RLF recovery.

According to an embodiment of the disclosure, the method further comprises transmitting, to the selected base station, an NCR report related to the RLF.

According to an embodiment of the disclosure, the NCR report comprises at least one of information related to a UE connected to the NCR or information related to an NCR Forward.

According to an embodiment of the disclosure, the NCR report comprises information related to an NCR Forward mode of a UE connected to the NCR.

In accordance with an aspect of the disclosure, a Network Control Repeater (NCR) in a wireless communication system is provided. The NCR comprises a transmitter, a receiver, and at least one processor coupled to the transmitter and the receiver. The at least one processor is configured to determine whether a radio link failure (RLF) between the NCR and a first base station occurred. The at least one processor is configured to in case that the RLF between the NCR and the first base station occurred, perform cell selection for radio resource control (RRC) connection procedure. The at least one processor is configured to, based on the result of the performing cell selection procedure, perform the RRC connection procedure with a selected base station.

What is claimed is:

1. A method performed by a network control repeater (NCR) in a wireless communication system, the method comprising:
determining whether a radio link failure (RLF) between the NCR and a first base station occurred;
in case that the RLF between the NCR and the first base station occurred, performing cell selection for a radio resource control (RRC) connection procedure; and
based on a result of the performing of the cell selection, performing the RRC connection procedure with a selected base station.

2. The method of claim 1, wherein the performing of the cell selection comprising:
selecting the first base station based on a configuration of the NCR.

3. The method of claim 1, further comprising:
obtaining a list of base stations,
wherein the performing of the cell selection comprising:
selecting a second base station based on the list of the base stations.

4. The method of claim 3,
wherein the list of the base stations comprises at least one of candidate base stations or forbidden base stations,
wherein the candidate base stations are allowed to connect with the NCR, and
wherein the forbidden base stations are not allowed to connect with the NCR.

5. The method of claim 3, wherein the list of the base stations is obtained from an operations, administration and maintenance (OAM).

6. The method of claim 1, further comprising:
in case that the RLF between the NCR and the first base station occurred, transmitting, to a user equipment (UE) connected to the NCR, an indication that the RLF occurred between the NCR and the first base station.

7. The method of claim 1, further comprising:
in case that the RRC connection between the NCR and the selected base station is established, transmitting, to a user equipment (UE) connected to the NCR, an indication indicating RLF recovery.

8. The method of claim 1, further comprising:
transmitting, to the selected base station, an NCR report related to the RLF.

9. The method of claim 8, wherein the NCR report comprises at least one of information related to a user equipment (UE) connected to the NCR, or information related to an NCR Forward.

10. The method of claim 8, wherein the NCR report comprises information related to an NCR Forward mode of a user equipment (UE) connected to the NCR.

11. A network control repeater (NCR) in a wireless communication system, the NCR comprising:
a transmitter;
a receiver; and
at least one processor coupled to the transmitter and the receiver, and configured to:
determine whether a radio link failure (RLF) between the NCR and a first base station occurred,
in case that the RLF between the NCR and the first base station occurred, perform cell selection for a radio resource control (RRC) connection procedure, and
based on a result of the performing of the cell selection, perform the RRC connection procedure with a selected base station.

12. The NCR of claim 11, wherein the at least one processor further configured to:
select the first base station for the RRC connection procedure based on a configuration of the NCR.

13. The NCR of claim 11, wherein the at least one processor further configured to:
obtain a list of base stations; and
select a second base station for the RRC connection procedure based on the list of the base stations.

14. The NCR of claim 13,
wherein the list of the base stations comprises at least one of candidate base stations or forbidden base stations,
wherein the candidate base stations are allowed to connect with the NCR, and
wherein the forbidden base stations are not allowed to connect with the NCR.

15. The NCR of claim 13, wherein the list of the base stations is obtained from an operations, administration and maintenance (OAM).

16. The NCR of claim 11, wherein the at least one processor further configured to:
in case that the RLF between the NCR and the first base station occurred, transmit, to a user equipment (UE) connected to the NCR, an indication that the RLF occurred between the NCR and the first base station.

17. The NCR of claim 11, wherein the at least one processor further configured to:
in case that the RRC connection between the NCR and the selected base station is established, transmit, to a user equipment (UE) connected to the NCR, an indication indicating RLF recovery.

18. The NCR of claim 11, wherein the at least one processor further configured to:
transmit, to the selected base station, an NCR report related to the RLF.

19. The NCR of claim 18, wherein the NCR report comprises at least one of information related to a user equipment (UE) connected to the NCR, or information related to an NCR Forward.

20. The NCR of claim 18, wherein the NCR report comprises information related to an NCR Forward mode of a user equipment (UE) connected to the NCR.
